(19) United States
(12) Patent Application Publication
(10) Pub. No.: US 2008/0223927 A1
(43) Pub. Date: Sep. 18, 2008

(54) ENTRY AND EXIT CONTROL APPARATUS

(76) Inventors: Keiji Otaka, Nara (JP); Makoto Ohashi, Kyoto (JP); Soichiro Kita, Nara (JP); Akira Nakajima, Shiga (JP)

Correspondence Address: DICKSTEIN SHAPIRO LLP, 1825 EYE STREET NW, Washington, DC, 20006-5403, US

(21) Appl. No.: 12/047,947

(22) Filed: Mar. 13, 2008

(30) Foreign Application Priority Data
Mar. 14, 2007 (JP) 2007-064383

(51) Int. Cl. B44B 5/00

(52) U.S. Cl. 235/382

(57) ABSTRACT

An entry and exit control apparatus wherein missing entry and exit information on a user entering and exiting a controlled area by tailgating is complemented by entry and exit information on another user presumed to enter and exit the controlled area along with the user that is tailgating. Therefore, reliability of user entry and exit history is improved to sufficiently suppress a decrease in security in the controlled area. The entry and exit control apparatus estimates entry and exit date and time concerning the missing entry and exit information based on the statistically processed staying time information of the user and the traveling time information for the entry and exit date information of the user determined that a missing item is generated, extracts complementary entry and exit information from pieces of entry and exit information stored in an entry and exit history DB based on the estimated entry and exit date and time, and complements the missing entry and exit information on the user using the extracted complementary entry and exit information.

### REFERENCE TO RELATED APPLICATIONS

This application claims priority to Japanese Patent Application No. 064383/2007, filed Mar. 14, 2007, the entirety of which is incorporated herein by reference.

### BACKGROUND OF THE INVENTION

1. Field of the Invention

The present invention relates to an entry and exit control apparatus which controls entry and exit of a user in a controlled area.

2. Description of the Related Art

Conventionally, there is an entry and exit control system which controls the entry and exit of the user in the controlled area. The controlled area shall mean an area that a person who can enter and exit is restricted. For example, the controlled area is set in a unit of a whole building or a room in the building. In the usual entry and exit control system, an electronic lock is attached to a door provided in a gate of the controlled area. Readers are disposed on both sides across the door of the controlled area, i.e., inside and outside the controlled area. The readers may be those which read identification information (user ID) stored in a medium such as a magnetic card, an IC card, a noncontact IC card, and an RF tag which is published to the user, or readers which read biometric information such as a fingerprint, a palm pattern, an iris, and a face of the user. Using the authentication information (such as the user ID and biometric information) read by the reader, the entry and exit control system determines whether or not the user is permitted to enter and exit the controlled area, and the entry and exit control system controls locking and unlocking of the electronic lock according to the determined result. The entry and exit control system stores user entry and exit history in the controlled area in the entry and exit control apparatus.

In the entry and exit control system, when so-called “tailgating” (in which another user enters and exits the controlled area along with the user who is permitted to enter and exit the controlled area) is generated, entry and exit information on the user who enters and exits the controlled area by tailgating is not left in the history in the entry and exit control apparatus. That is, the entry and exit information on the user is missing in the controlled area. As a result, the entry and exit control apparatus cannot correctly control the entry and exit of the user in the controlled area thereby decreasing security of the controlled area.

Therefore, there is proposed a technique of complementing the missing entry and exit information on the user (refer to, for example, Japanese Patent Application Laid-Open Nos. 2002-208050, 2003-44891, and 2006-65572). Japanese Patent Application Laid-Open No. 2002-208050 discloses a configuration in which the missing entry and exit information is complemented using information on login or logout of a server of a personal computer (PC). Japanese Patent Application Laid-Open No. 2003-44891 discloses a configuration in which the user is presumed to return to a previously-set floor from a current floor (controlled area) by tailgating when a predetermined time elapses with no access, thereby complementing the entry and exit information. Japanese Patent Application Laid-Open No. 2006-65572 discloses a configuration in which the missing entry and exit information is complemented from the entry and exit information on the user based on an understood behavioral pattern of the user.

However, the entry and exit information on the user who enters and exits the controlled area by tailgating should be complemented by entry and exit information on another user who enters and exits the controlled area along with the tailgating user. On the other hand, in Japanese Patent Application Laid-Open Nos. 2002-208050, 2003-44891, and 2006-65572, the entry and exit information to be complemented is newly generated as described above. That is, the missing entry and exit information on the user is complemented by the entry and exit information in which the user who enters and exits the controlled area does not actually exist. Therefore, the user entry and exit history in the controlled area becomes improper to hardly suppress the decrease in security of the controlled area.

An object of the invention is to provide an entry and exit control apparatus, wherein missing entry and exit information on a user entering and exiting the controlled area by tailgating is complemented by entry and exit information on another user presumed to enter and exit the controlled area along with the user that is tailgating, whereby the reliability of user entry and exit history is improved to sufficiently suppress the decrease in security in the controlled area.

### SUMMARY OF THE INVENTION

An entry and exit control apparatus of the present invention has the following configuration in order to solve the problems to achieve the object.

In an entry and exit control apparatus according to an aspect of the present invention, entry and exit information is cumulatively stored in an entry and exit history storage unit. A user, a controlled area which the user enters and exits, a type of entry and exit, and entry and exit date and time are related to one another in the entry and exit information. Staying time information is stored in a staying time information storage unit. A user staying time is statistically processed in each controlled area in the staying time information. Traveling time information is stored in a traveling time information storage unit. A user traveling time between two controlled areas is statistically processed in the traveling time information.

A missing determination unit determines whether or not the entry and exit information stored in the entry and exit history storage unit is missing in each user. For example, in the case where the entry and exit information on a certain user is checked in time series, when the entry and exit information indicating that the user enters the first controlled area and the entry and exit information indicating that the user enters the second controlled area are temporally continued, the missing determination unit determines that the entry and exit information indicating that the user exits the first controlled area is missing during this period. When the entry and exit information indicating that the user exits the first controlled area and the entry and exit information indicating that the user exits the second controlled area are temporally continued, the missing determination unit determines that the entry and exit information indicating that the user enters the second controlled area is missing during this period. When the entry and exit information indicating that the user enters the first controlled area and the entry and exit information indicating that the user exits the second controlled area are temporally continued, the missing determination unit determines that the entry and exit information indicating that the user exits the first controlled area and the entry and exit information indicating that the user enters the second controlled area are missing during this period.

An estimation unit estimates entry and exit date and time for the entry and exit information on the user that the missing determination unit determines is missing based on the staying time information on the corresponding controlled area and the traveling time information between the two corresponding controlled area. A complementary entry and exit information extraction unit extracts complementary entry and exit information from the pieces of entry and exit information stored in the entry and exit history storage unit based on the entry and exit date and time estimated by the estimation unit. A complementary unit complements the entry and exit information that the missing determination unit determines is missing by the complementary entry and exit information extracted by the complementary entry and exit information extraction unit. Thus, the missing entry and exit information on the user entering and exiting the controlled area by tailgating is complemented by the entry and exit information on another user estimated to enter and exit the controlled area along with the user that is tailgating. As described above, the staying time information and the traveling time information are statistically processed, so that the estimation accuracy of the entry and exit date and time can be ensured in the estimation unit. Therefore, the entry and exit information on another user estimated to enter and exit the controlled area along with the user that is tailgating can accurately be extracted in the complementary entry and exit information extraction unit. Accordingly, the reliability of the user entry and exit history can be improved to sufficiently suppress the decrease in security in the controlled area.

The complementary entry and exit information extraction unit may extract the entry and exit information on the controlled area temporally closest to the entry and exit date and time estimated by the estimation unit, and the complementary entry and exit information extraction unit may extract the entry and exit information on the corresponding controlled area, in which a time during which a door of the controlled area is opened becomes maximum in a period of time having a predetermined time interval around the entry and exit date and time estimated by the estimation unit, as the complementary entry and exit information.

The complementary unit may make an inquiry whether or not complementation is performed by the entry and exit information extracted by the complementary entry and exit information extraction unit, and the complementary unit may complement the missing entry and exit information in response to the inquiry. In this configuration, the complementary entry and exit information extraction unit may extract plural pieces of entry and exit information and present the pieces of entry and exit information as a complementary candidate.

The missing determination unit may determine whether or not the entry and exit information on the user is missing when the entry and exit information is stored in the entry and exit history storage unit.

In accordance with the invention, the missing entry and exit information on a user entering and exiting the controlled area by tailgating is complemented by entry and exit information on another user entering and exiting the controlled area along with the user that is tailgating. Therefore, the reliability of the user entry and exit history can be improved to sufficiently suppress the decrease in security in the controlled area.

### BRIEF DESCRIPTION OF THE DRAWINGS

FIG. 1 shows a schematic diagram of a configuration of an entry and exit control system according to an embodiment of the invention.

FIG. 2 shows a schematic diagram near a gate of a controlled area.

FIG. 3 shows a block diagram of a configuration of a main part of an entry and exit control apparatus.

FIG. 4 shows an authentication condition stored in an authentication condition database.

FIG. 5 shows entry and exit information stored in an entry and exit history database.

FIG. 6 shows staying time information stored in a behavioral pattern database.

FIG. 7 shows traveling time information stored in the behavioral pattern database.

FIG. 8 shows a determination condition stored in a tailgating knowledge database.

FIG. 9 shows a block diagram of a configuration of a main part of an opening and closing device.

FIG. 10 shows a block diagram of a configuration of a main part of a reader.

FIG. 11 shows a flowchart of an operation of the reader.

FIG. 12 shows a flowchart of an operation of the opening and closing device.

FIG. 13 shows a flowchart of an operation of the entry and exit control apparatus.

FIG. 14 shows a flowchart of complementary processing in the entry and exit control apparatus.

FIG. 15 shows a view explaining the complementary processing in the entry and exit control apparatus.

FIG. 16 shows a view explaining the complementary processing in the entry and exit control apparatus.

FIG. 17 shows a view explaining the complementary processing in the entry and exit control apparatus.

### DETAILED DESCRIPTION OF THE PREFERRED EMBODIMENTS

An embodiment according to the present invention will be described below.

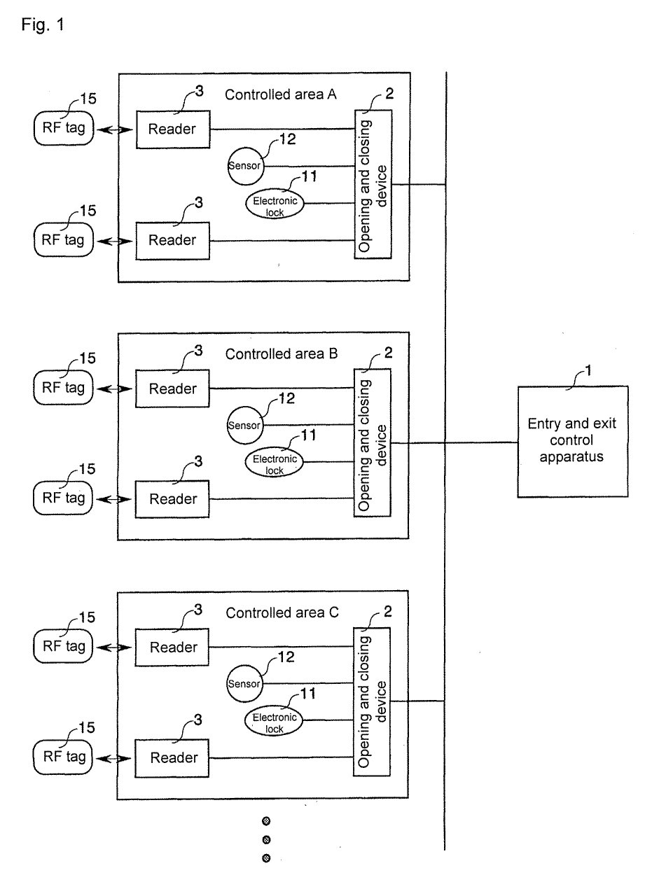

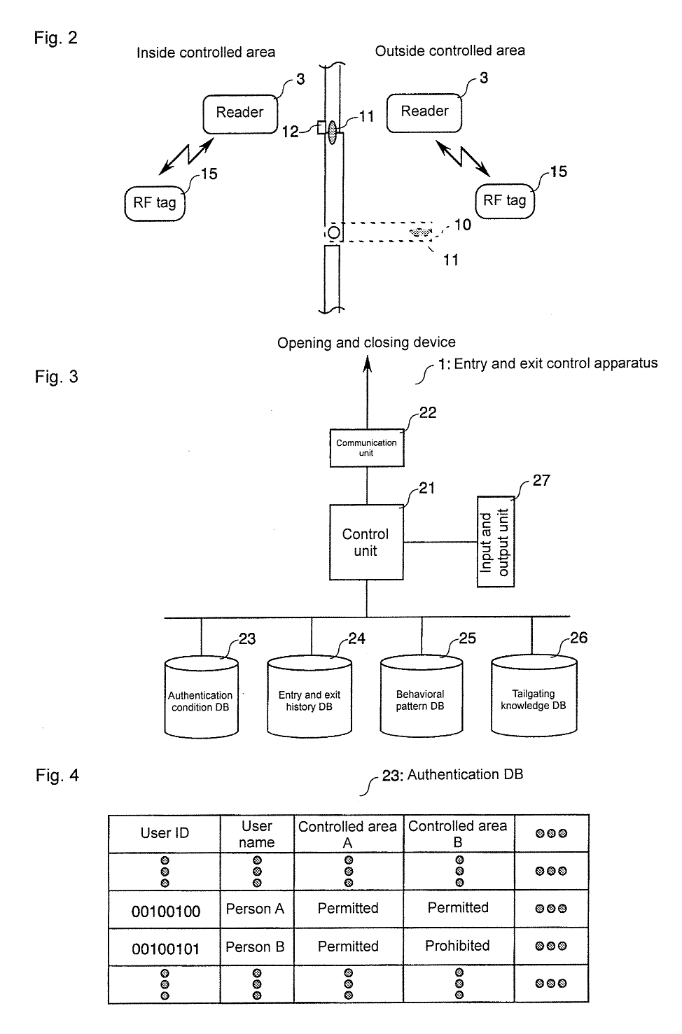

FIG. 1 shows a schematic diagram of a configuration of an entry and exit control system according to an embodiment of the invention. The entry and exit control system is a system in which an entry and exit control apparatus 1 placed in a center controls entry and exit of a user in plural controlled areas. FIG. 1 shows only the three controlled areas A, B and C. FIG. 2 shows a schematic diagram near a gate of the controlled area. An electronic lock 11 and a sensor 12 are attached to a door 10 of the controlled area. The electronic lock 11 restricts opening and closing of the door 10. The sensor 12 detects opened and closed states of the door 10. FIG. 2 shows the closed state of the door 10 with a broken line. An opening and closing device 2 controls the lock/unlock of the electronic lock 10. The sensor 12 can detect the opened and closed states of the door 10. The sensor 12 may be formed by a micro switch which is pressed when the door 10 is closed and not pressed when the door 10 is opened. The sensor 12 may be formed by a photo-electric sensor in which a light emitting portion and a light acceptance portion face each other when the door 10 is closed and in which the light emitting portion and the light acceptance portion do not face each other when the door 10 is opened, or the sensor 12 may be formed by another kind of sensor. Readers 3 are disposed on both sides across the door 10 of the controlled area, namely the readers 3 are disposed inside and outside the controlled area. The readers 3 read identification information stored in an RF tag 15 as a user ID through wireless communication with the RF tag 15 published to the user. The readers 3 are connected to the opening and closing device 2, and the readers 3 transmit reading notification to the opening and closing device 2. The reading notification includes the read user ID and device ID for identifying the device of itself. The device ID included in the reading notification can determine whether the reader 3 which reads the user ID is disposed outside or inside the controlled area. That is, it can be determined whether the user is entering the controlled area or is exiting the controlled area. The opening and closing device 2 is connected to the entry and exit control apparatus 1.

When receiving the reading notification from the reader 3, the opening and closing device 2 makes an authentication request to an entry and exit control apparatus 1. The authentication request includes the user ID, a controlled area number for identifying the controlled area, and a type of entry and exit. The opening and closing device 2 stores the controlled area number in itself. The controlled area number may be a device ID for identifying the opening and closing device 2. When receiving the authentication request from the opening and closing device 2, the entry and exit control apparatus 1 determines whether or not the user identified by the user ID included in the authentication request is permitted to enter and exit the controlled area identified by the controlled area number, and the entry and exit control apparatus 1 sends back the determined result to the opening and closing device 2. The entry and exit control apparatus 1 stores entry and exit information on the current authentication request. The entry and exit information includes the user ID, the controlled area, the type of entry and exit, entry and exit date and time, and the determined result.

The opening and closing device 2 controls the lock/unlock of the electronic lock 11 based on the determined result from the entry and exit control apparatus 1. The opening and closing device 2 usually locks the electronic lock 11, and the opening and closing device 2 unlocks the electronic lock 11 when receiving the determined result for permitting the user to entry and exit the controlled area from the entry and exit control apparatus 1. The opening and closing device 2 measures opened and closed times of the door 10 when unlocking the electronic lock 11. Specifically, after unlocking the electronic lock 11, the opening and closing device 2 measures a time until the door 10 is closed using an output of the sensor 12. When detecting that the door 10 is closed, the opening and closing device 2 locks the electronic lock 11. The opening and closing device 2 notifies the entry and exit control apparatus 1 of the measured door opened time. The entry and exit control apparatus 1 adds the currently-received door opened time to the corresponding entry and exit information.

The controlled area may have a gate or plural gates. In the case of the plural gates, the door 10, the electronic lock 11, the sensor 12, the opening and closing device 2, and the two readers 3 are provided in each gate.

FIG. 3 shows a block diagram of a configuration of a main part of the entry and exit control apparatus. The entry and exit control apparatus 1 includes a control unit 21, a communication unit 22, an authentication condition database 23 (hereinafter referred to as authentication condition DB 23), an entry and exit history database 24 (hereinafter referred to as entry and exit history DB 24), a behavioral pattern database 25 (hereinafter referred to as behavioral pattern DB 25), a tailgating knowledge database 26 (hereinafter referred to as tailgating knowledge DB 26), and an input and output unit 27. The control unit 21 controls an operation of each unit. The communication unit 22 controls communication with the opening and closing device 2.

An authentication condition (refer to FIG. 4) is stored in the authentication condition DB 23. In the authentication condition, a user name of each user ID is related to permission/prohibition of the entry and exit in each controlled area. FIG. 4 shows authentication conditions for a person A whose user ID is “00100100” and a person B whose user ID is “00100101”. The person A is permitted to enter and exit a controlled area A and a controlled area B. On the other hand, the person B is permitted to enter and exit the controlled area A while prohibited from entering and exiting the controlled area B. Although not shown, the permission/prohibition of the entry and exit in other controlled areas is also registered for the persons A and B.

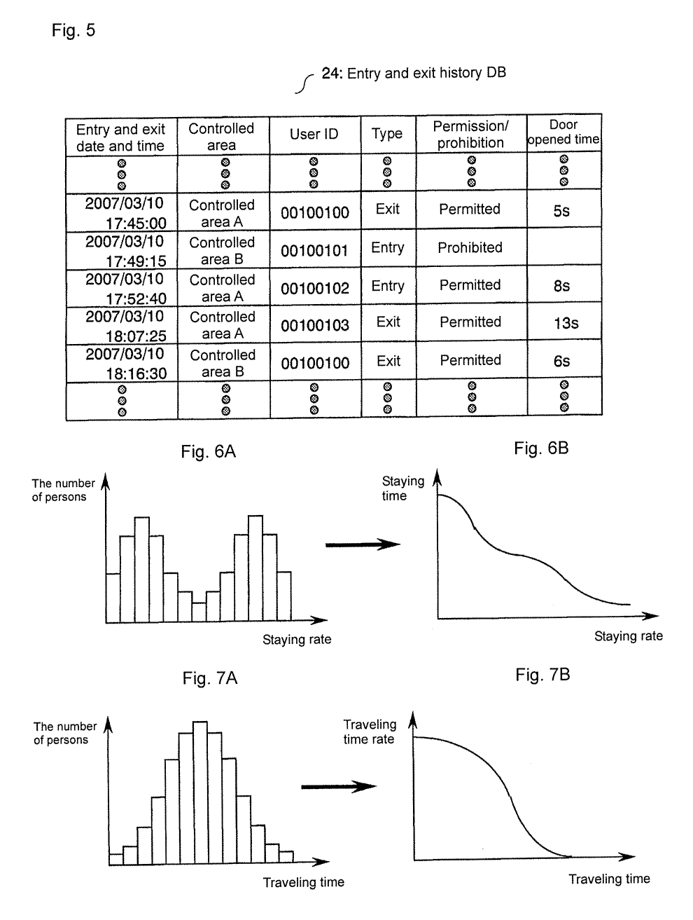

Entry and exit information is cumulatively stored in the entry and exit history DB 24. The entry and exit date and time, the controlled area, the user name, the type of entry and exit, a type of permission/prohibition of the entry and exit, and the opened time of the door 10 entry and exit information are related to one another in the entry and exit information (refer to FIG. 5). The entry and exit date and time are not a time when the user actually enters and exits the controlled area, but a time when the authentication request is received from the opening and closing device 2. However, the time when the authentication request is received from the opening and closing device 2 is substantially identical to the time when the user actually enters and exits the controlled area. In the example shown in FIG. 5, the entry and exit information on the prohibition in which the user is not permitted to enter and exit the controlled area is also stored in the entry and exit history DB 24. Alternatively, there may be a configuration in which the entry and exit information on the prohibition is not stored in the entry and exit history DB 24. FIG. 5 shows missing of the entry and exit information indicating that the person A enters the controlled area B after the person A exits the controlled area A. In this case, as described later, it is determined that the person A enters the controlled area B by tailgating.

Staying time information and traveling time information are stored in the behavioral pattern DB 25. The staying time information indicates a distribution of a user staying time in each controlled area, and the traveling time information indicates a distribution of a user traveling time in each two controlled areas. The behavioral pattern DB 25 is of the staying time information storage unit and the traveling time information storage unit.

First the staying time information will be described. The staying time information is a staying rate function indicating a user staying rate with time, and the staying time information of each controlled area is stored in the behavioral pattern DB 25. The staying rate function is one in which the user staying time is statistically processed in the target controlled area. Specifically, for a certain controlled area, the staying time is divided by a five-minute time interval, and the number of persons is counted in each divided staying time. The staying time of each user in the controlled area can be obtained from the entry and exit information stored in the entry and exit history DB 24. The user who enters and exits the controlled area plural times can be counted as one user in each entry of exit. Therefore, a relationship (bar graph) between the staying time and the number of users is obtained as shown in FIG. 6A. The relationship between the staying time and the number of users is normalized to compute a function (graph shown in FIG. 6B) indicating the user staying rate with time, and the function is stored as the staying rate function in the behavioral pattern DB 25.

The traveling time information is a traveling time rate function which indicates a statistically-processed rate of traveling user with time for the travel between the two controlled areas. The traveling time rate function is stored in the behavioral pattern DB 25 in each combination of the two controlled areas and in each traveling direction. For example, the traveling time rate function from the controlled area A to the controlled area B and the traveling time rate function from the controlled area B to the controlled area A are stored for the combination of the controlled area A and the controlled area B. Similarly to the staying rate function, in the traveling time rate function, the two target controlled areas and the number of users in the traveling direction are counted in each divided traveling time, and the relationship (FIG. 7A) between the obtained traveling time and the number of users are normalized to compute the function (traveling time rate function) (FIG. 7B).

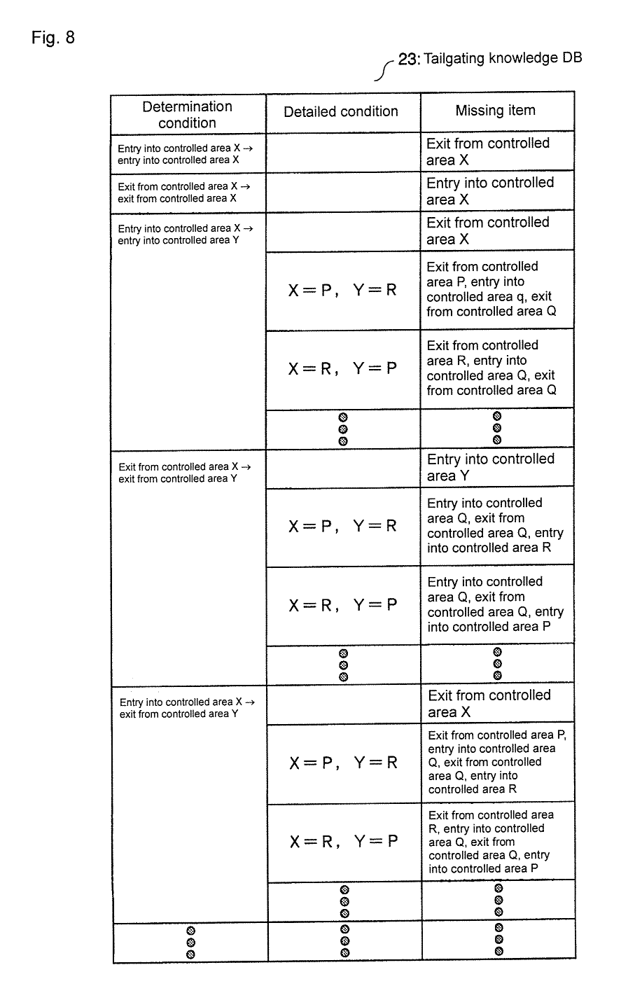

A determination condition for determining the entry and exit of the user that is tailgating and contents (missing item) of the entry and exit information (missing entry and exit information) which should be complemented to the user who is determined as having entered or exited by tailgating are stored in the tailgating knowledge DB 26 while related to each other (refer to FIG. 8). The missing item indicates the controlled area and the type of entry and exit for the controlled area. For example, when the user temporally continuously performs the entry into a controlled area X and the entry into the controlled area Y, the exit of the controlled area X is set as the missing item.

In FIG. 8, controlled areas X and Y indicate not one particular controlled area but any controlled area.

FIG. 8 shows detailed conditions in the case where the entry and exit information to be complemented is out of the usual case depending on an environment of a place where the controlled area is provided. For example, in the usual case, when the user temporally continuously performs the entry into the controlled area X and the entry into the controlled area Y, the exit from the controlled area X is the entry and exit information to be complemented. However, in an environment in which a particular controlled area Q exists between a controlled area P and a controlled area R and the user needs to pass through the controlled area Q when traveling from the controlled area P to the controlled area R, the entry and exit information to be complemented includes not only the exit from the controlled area P but also the entry into the controlled area Q and the exit from the controlled area Q. Using the determination condition, the entry and exit control apparatus 1 determines whether or not a missing item is generated in the entry and exit information. When a missing item is generated, the entry and exit control apparatus 1 determines the missing item based on the set detailed conditions.

A terminal, such as a personal computer, which is manipulated by an operator is connected to the input and output unit 27.

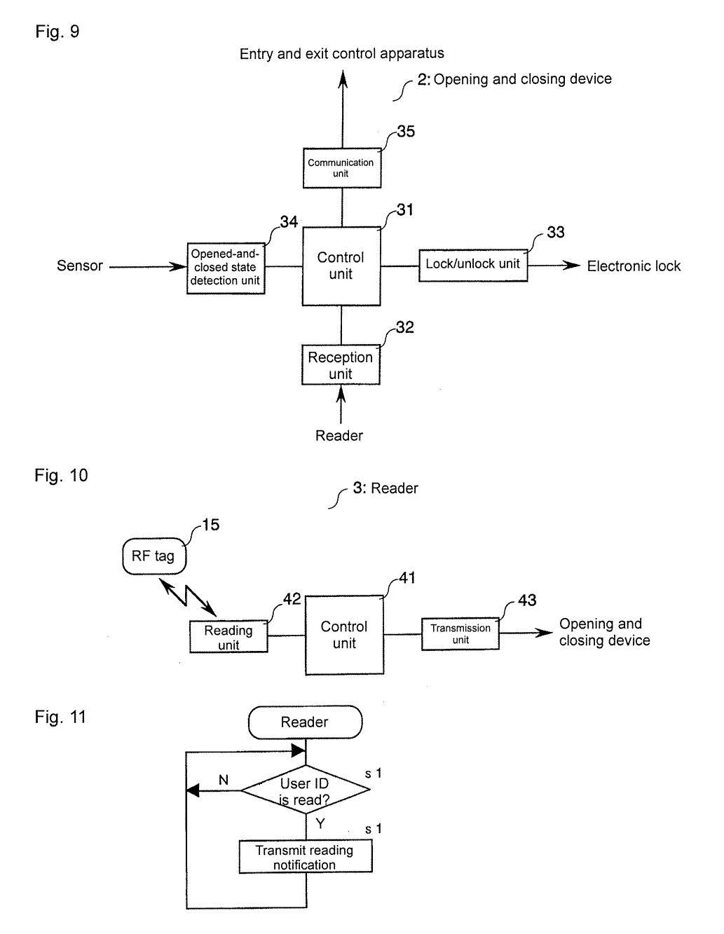

FIG. 9 shows a block diagram of a configuration of a main part of the opening and closing device. The opening and closing device 2 includes a control unit 31, a reception unit 32, a lock/unlock unit 33, an opened-and-closed state detection unit 34, and a communication unit 35. The control unit 31 controls an operation of each unit. The reception unit 32 receives the reading notification transmitted from the reader 3. The reading notification includes the user ID and the device ID. The lock/unlock unit 33 controls the state of the connected electronic lock 11. The opened-and-closed state detection unit 34 detects the opened and closed states of the door 10 based on the output of the connected sensor 12. The communication unit 35 controls the communication with the entry and exit control apparatus 1.

FIG. 10 shows a block diagram of a configuration of a main part of the reader. The reader 3 includes a control unit 41, a reading unit 42, and a transmission unit 43. The control unit 41 controls an operation of each unit. The reading unit 42 conducts wireless communication with the RF tag 15 possessed by the user, and the reading unit 42 reads the user ID stored in the RF tag 15. The transmission unit 43 transmits the reading notification to the opening and closing device 2. The reading notification includes the device ID and the user ID read from the RF tag 15 with the reading unit 42. The reader 3 stores the device ID in a memory provided in the control unit 41.

Then, an operation of each unit in the entry and exit control system will be described. Usually the door 10 of the controlled area is closed and locked by the electronic lock 11. FIG. 11 shows a flowchart of an operation of the reader. When reading the user ID from the RF tag 15 possessed by the user who wants to enter and exit the controlled area (Step S1), the reader 3 transmits the reading notification including the read user ID and stored device ID to the opening and closing device 2 (Step S2). The user who wants to enter and exit the controlled area holds the RF tag 15 in a reading area (wireless communication area) of the reading unit 42 to cause the reading unit 42 to read the user ID stored in the RF tag 15. Accordingly, the reader 3 transmits the user ID of the user who wants to enter and exit the controlled area to the opening and closing device 2. The reader 12 repeats the pieces of processing in Steps S1 and S2.

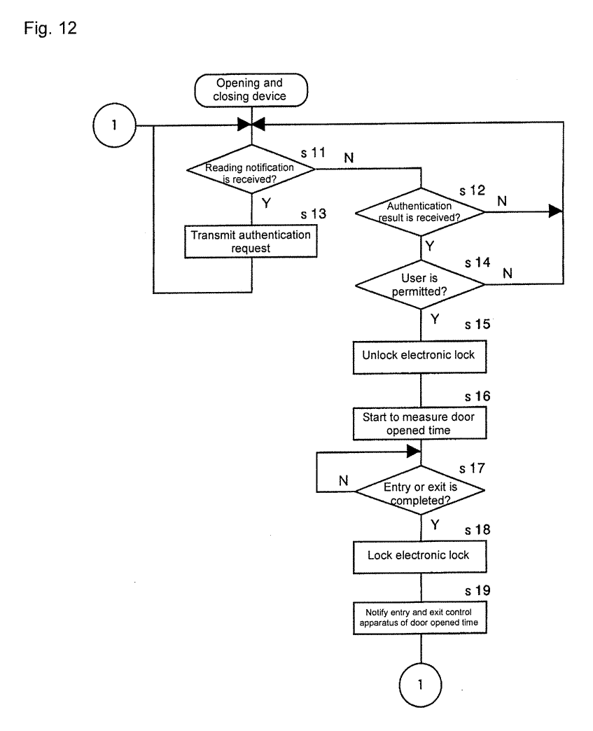

FIG. 12 shows a flowchart of an operation of the opening and closing device 2. The opening and closing device 2 waits for the reception unit 32 to receive the reading notification from the reader 3 or waits for the communication unit 35 to receive the later-mentioned authentication result concerning the entry and exit of the user into and from the controlled area from the entry and exit control apparatus 1 (Steps S11 and S12). When the reception unit 32 receives the reading notification transmitted from the reader 3, the opening and closing device 2 transmits the authentication request to the entry and exit control apparatus 1 (Step S13), and the flow returns to Step S11. As described above, the authentication request includes the user ID, the controlled area number, and the type of entry and exit.

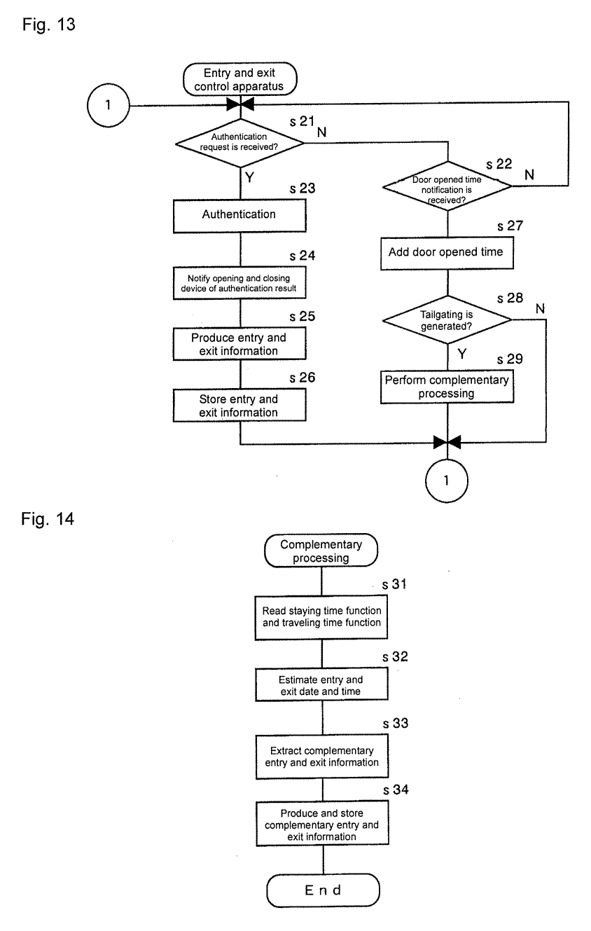

FIG. 13 shows a flowchart of an operation of the entry and exit control apparatus. The entry and exit control apparatus 1 waits for the communication unit 22 to receive the authentication request from the opening and closing device 2, or waits for notification of the later-mentioned door opened time from the opening and closing device 2 (Steps S21 and S22). When receiving the authentication result from the opening and closing device 2, the entry and exit control apparatus 1 determines whether or not the user enter and exit the controlled area based on the authentication request (Step S23). Specifically, the entry and exit control apparatus 1 search the authentication condition DB 23 by the user ID included in the currently-received authentication request, and the entry and exit control apparatus 1 determines whether or not the control area (identified by the controlled area number included in the authentication request) which the user wants to enter and exit is the controlled area which the user is permitted to enter and exit. The entry and exit control apparatus 1 sends back the authentication result indicating that the user is permitted to enter and exit the controlled area to the opening and closing device 2 when the control area which the user wants to enter and exit is the controlled area which the user is permitted to enter and exit, and on the contrary, the entry and exit control apparatus 1 sends back the authentication result indicating that the user is prohibited from entering and exiting the controlled area to the opening and closing device 2 when the control area which the user wants to enter and exit is a controlled area which the user is not permitted to enter and exit (Step S24). When the entry and exit control apparatus 1 sends back the authentication result to the opening and closing device 2, the entry and exit control apparatus 1 produces the entry and exit information on the user of which the current authentication request is transmitted (Step S25), and the entry and exit control apparatus 1 stored the entry and exit information in the entry and exit history DB 24 (Step S26). At this point, the entry and exit information stored in the entry and exit history DB 24 includes the entry and exit date and time, the controlled area, the user ID, the type of entry and exit, and the authentication result while the data is still empty for the opened time of the door 10.

When receiving the authentication result transmitted from the entry and exit control apparatus 1 in Step S12, the opening and closing device 2 determines whether the received authentication result is the result that the user is permitted to enter and exit the controlled area or the result that the user is prohibited from entering and exiting the controlled area (Step S14). When the authentication result is the result that the user is prohibited from entering and exiting the controlled area, the flow returns to Step S11. At this point, the user located near the door 10 of the controlled area may be notified that the user is not permitted to enter and exit the controlled area. In the case where the corresponding user wants to exit the controlled area, a notification that the user who is not permitted to enter and exit the controlled area enters the controlled area may be made to a security guard room.

On the other hand, when the entry and exit control apparatus 1 determines that authentication result is the result that the user is permitted to enter and exit the controlled area, the opening and closing device 2 unlocks the electronic lock 11 using the lock/unlock unit 33 (Step S15). In the opening and closing device 2, when the electronic lock 11 is unlocked, the opened-and-closed state detection unit 34 starts to detect the opened time of the door 10 (Step S16). The user opens the door 10 whose electronic lock 11 is unlocked, and the user enters or exits the controlled area. In Step S16, the opening and closing device 2 measures the opened time of the door 10 when the user enters or exits the controlled area. That is, after the electronic lock 11 is unlocked, the opening and closing device 2 causes the sensor 12 to detect the time until the door 10 is closed after the door 10 is opened. The opening and closing device 2 waits for the user to complete the entry into or exit from the controlled area (Step S17). The door 10 is tentatively opened and then the door 10 is closed, whereby the opening and closing device 2 to determine that the entry or exit of the user is completed. When the entry or exit of the user is completed, the opening and closing device 2 locks the electronic lock 11 (Step S18). The opening and closing device 2 notifies the entry and exit control apparatus 1 of the currently-measured opened time of the door 10 (door opened time) (Step S19), and the flow returns to Step S11.

When receiving the notification of the door opened time from the opening and closing device 2 in Step S22, the entry and exit control apparatus 1 adds the currently-notified door opened time to the corresponding entry and exit information stored in the entry and exit history DB 24 in Step S26 (Step S27). The entry and exit control apparatus 1 determines whether or not the entry and exit information is missing for the user whose door opened time is currently added (Step S28). In Step S28, for the user, the entry and exit control apparatus 1 extracts the entry and exit information to which the door opened time is currently added and the previously-stored entry and exit information from the entry and exit history DB 24, and the entry and exit control apparatus 1 determines whether or not tailgating is generated during this time based on the determination condition registered in the tailgating knowledge DB 26. When tailgating is generated, the entry and exit control apparatus 1 determines the missing item of the missing entry and exit information based on the detailed conditions. When the entry and exit control apparatus 1 determines in Step S28 that tailgating is not generated, namely, when the entry and exit control apparatus 1 determines that the entry and exit information is not missing, the flow returns to Step S21 to repeat the above-described pieces of processing. On the contrary, when the entry and exit control apparatus 1 determines that tailgating is generated, the entry and exit control apparatus 1 performs complementary processing for complementing the missing entry and exit information (Step S29), and the flow returns to Step S21.

The detailed complementary processing in Step S29 will be described below. FIG. 14 shows a flowchart of complementary processing in the entry and exit control apparatus 1. The entry and exit control apparatus 1 reads the staying rate function and traveling time rate function, used in the complementary processing, from the behavioral pattern DB 25 based on the missing item of the missing entry and exit information (Step S31). For example, in the case where the entry and exit information on the exit from the controlled area A is missing between the entry into the controlled area A and the entry into the controlled area B, the staying rate function of the controlled area A and the traveling time rate function from the controlled area A to the controlled area B are read from the behavioral pattern DB 25. In the case where the entry and exit information on the entry into the controlled area B is missing between the exit from the controlled area A and the exit from the controlled area B, the staying rate function of the controlled area B and the traveling time rate function from the controlled area A to the controlled area B are read from the behavioral pattern DB 25. In the case where three pieces of entry and exit information on the exit from the controlled area P, the entry into the controlled area Q, and the exit from the controlled area Q are missing between the entry into the controlled area P and the entry into the controlled area R, the staying rate function of the controlled area P, the traveling time rate function from the controlled area P to the controlled area Q, the staying rate function of the controlled area Q, and the traveling time rate function from the controlled area Q to the controlled area R are read from the behavioral pattern DB 25.

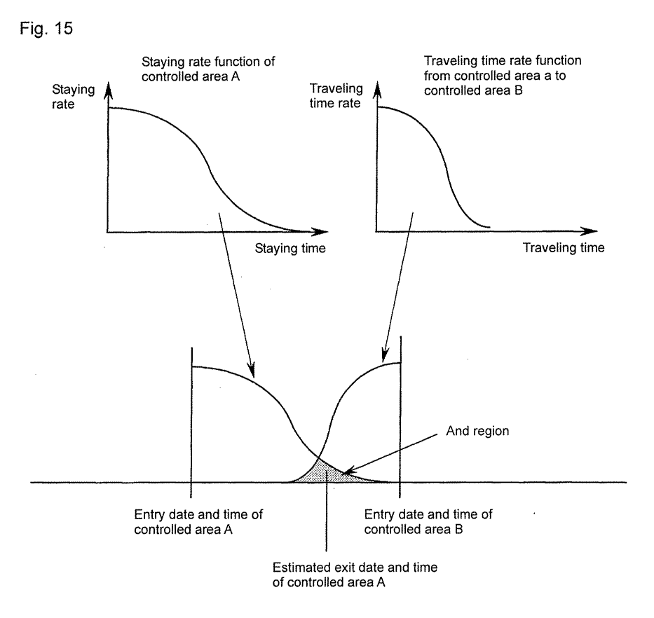

On the basis of the staying rate function and traveling time rate function read in Step S31, the entry and exit control apparatus 1 estimates the entry and exit date and time of the missing entry and exit information on the user (Step S32). For example, in the case where the entry and exit information on the exit from the controlled area A is missing between the entry into the controlled area A and the entry into the controlled area B, as shown in FIG. 15, the staying rate function of the controlled area A is disposed based on the entry date and time of the controlled area A, the traveling time rate function from the controlled area A to the controlled area B is disposed based on the entry date and time of the controlled area B, and a barycenter of overlapping portions of the two functions (hereinafter referred to as AND region), shown by a hatching in FIG. 15, is estimated as the missing entry and exit date and time concerning the exit from the controlled area A. The entry date and time of the controlled area A and the entry date and time of the controlled area B are already known because the entry and exit information exists.

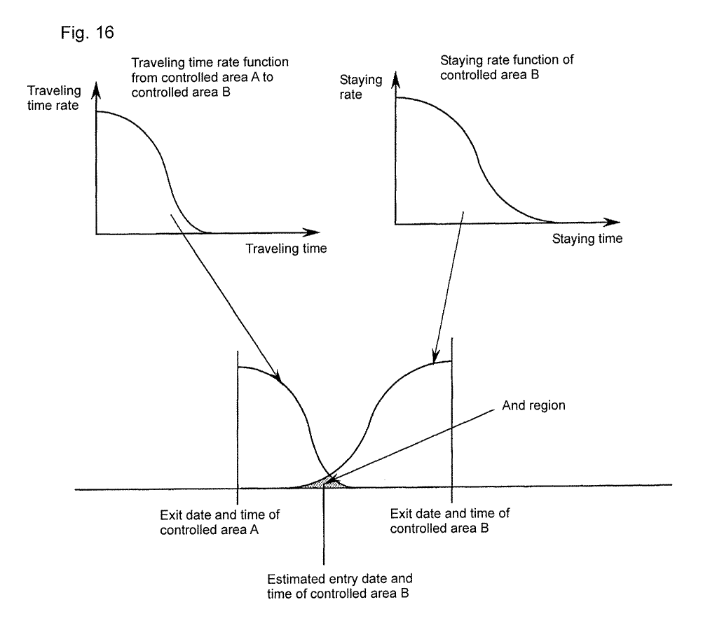

In the case where the entry and exit information concerning the entry into the controlled area B is missing between the exit from the controlled area A and the exit from the controlled area B, as shown in FIG. 16, the traveling time rate function from the controlled area A to the controlled area B is disposed based on the exit date and time of the controlled area A, and the barycenter of the AND region is estimated as the missing entry and exit date and time concerning the entry into the controlled area B when the staying rate function of the controlled area B is disposed based on the exit date and time of the controlled area B. The exit date and time of the controlled area A and the exit date and time of the controlled area B are already known because the entry and exit information exists.

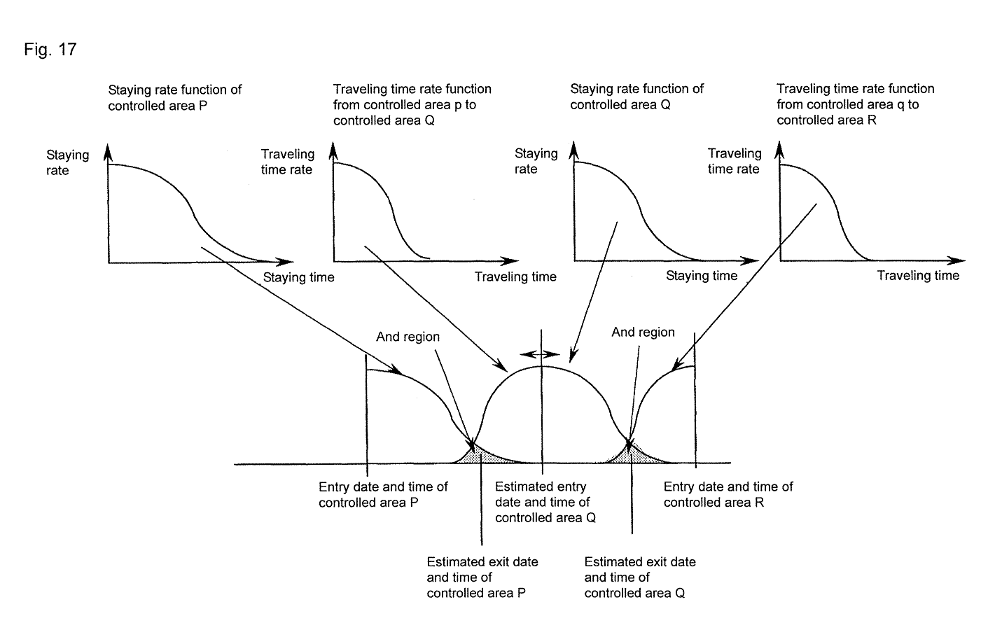

In the case where the three pieces of entry and exit information on the exit from the controlled area P, the entry into the controlled area Q, and the exit from the controlled area Q are missing between the entry into the controlled area P and the entry into the controlled area R, as shown in FIG. 17, the staying rate function of the controlled area P is disposed based on the entry date and time of the controlled area P, and the traveling time rate function from the controlled area Q to the controlled area R is disposed based on the entry date and time of the controlled area R. An entry date and time axis indicating the entry date and time of the controlled area Q is set to proper time between the entry into the controlled area P and the entry into the controlled area R, and the traveling time rate function from the controlled area P to the controlled area Q relative to the entry date and time axis and the staying rate function of the controlled area Q are disposed. The entry date and time of the controlled area P and the entry date and time of the controlled area R are already known because the entry and exit information exists. Then, the entry date and time axis indicating the entry date and time of the controlled area Q is shifted to a position, at which an area of the AND region where the staying rate function of the controlled area P and the traveling time rate function from the controlled area P to the controlled area Q overlap each other becomes identical to an area of the AND region where the staying rate function of the controlled area Q and the traveling time rate function from the controlled area Q to the controlled area R overlap each other. The barycenter of the AND region where the staying rate function of the controlled area P and the traveling time rate function from the controlled area P to the controlled area Q overlap each other is estimated as the missing entry and exit date and time concerning the exit from the controlled area P, and the barycenter of the AND region where the staying rate function of the controlled area P and the traveling time rate function from the controlled area P to the controlled area Q overlap each other is estimated as the missing entry and exit date and time concerning the exit from the controlled area Q. Additionally, the entry date and time axis indicating the entry date and time of the controlled area Q at this time is estimated as the entry and exit date and time concerning the entry into the controlled area Q.

On the basis of the entry and exit date and time estimated in Step S32, the entry and exit control apparatus 1 extracts complementary entry and exit information from the entry and exit history DB 24 in each missing entry and exit information (Step S33). In Step S33, the entry and exit information, which is of the entry and exit information of the corresponding controlled area and is temporally closest to the entry and exit date and time estimated in Step S32, is extracted as the complementary entry and exit information from the entry and exit history DB 24. On the basis of the entry and exit information extracted in Step S33, the entry and exit control apparatus 1 produces the currently-missing entry and exit information to store the entry and exit information in the entry and exit history DB 24 (Step S34). In Step S34, the entry and exit control apparatus 1 changes the user ID of the complementary entry and exit information extracted in Step S33, and the entry and exit control apparatus 1 produces the entry and exit information whose type of entry and exit is changed if needed.

Thus, the entry and exit control apparatus 1 estimates the entry and exit date and time of the missing entry and exit information on the user based on the staying rate function in which the user staying time is statistically processed in the target controlled area and the traveling time rate function indicating the rate of the traveling user with time, in which the travel between the two target controlled areas are statistically processed. Therefore, the entry and exit date and time of the missing entry and exit information on the user can be estimated with high accuracy. The entry and exit information in which tailgating is performed to the user whose entry and exit information is missing is set to the complementary entry and exit information based on the estimated entry and exit date and time, and the missing entry and exit information is complemented by the extracted complementary entry and exit information. Therefore, the reliability of the entry and exit information stored in the entry and exit history DB 24 can be improved to sufficiently suppress the decrease in security in the controlled area.

In the embodiment, the barycenter of the AND region is estimated as the entry and exit date and time in Step S32. Alternatively, an intersection point between the staying rate function and the traveling time rate function may be estimated as the entry and exit date and time.

In the embodiment, the entry and exit information which is temporally closest to the entry and exit date and time estimated in Step S32 is extracted as the complementary entry and exit information. Alternatively, the entry and exit information on the corresponding controlled area, which has the longest door opened time may be extracted as the complementary entry and exit information during a time interval previously determined around the entry and exit date and time estimated in Step S32, e.g., during ten minutes.

Alternatively, all the pieces of entry and exit information on the corresponding controlled area are extracted during a time interval previously determined around the entry and exit date and time estimated in Step S32, e.g., during ten minutes, the extracted entry and exit information is set to a candidate of the complementary entry and exit information, and what complementary entry and exit information complements the entry and exit information may be inquired. For example, the inquiry may be made from the input and output unit 27 to the connected terminal. In this case, the operator confirms the corresponding user by the telephone or electronic mail, and the notification of the complementary entry and exit information for complementing the missing entry and exit information may be inputted to the entry and exit control apparatus 1 using the terminal based on the confirmed contents. The entry and exit control apparatus 1 may complement the missing entry and exit information on the user based on the notification concerning the inquiry from the terminal. Alternatively, the entry and exit control apparatus 1 may directly make the inquiry to the user terminal.

In the embodiment, the determination whether or not the entry and exit information is missing for the corresponding user is made each time the door time notification is received from the opening and closing device 2, and the complementary processing is performed if needed. Alternatively, the determination whether or not the entry and exit information is missing for the corresponding user and the complementary processing in the case of the missing entry and exit information may be performed in a batch processing manner. After the processing in Step S26 is performed, the pieces of processing in Steps S28 and S29 may be performed.

Any device which reads the information for being able to identify the user can be used as the reader 3 of the embodiment, a device which reads the user ID from the magnetic card can be used as the reader 3, a device which reads the biometric information such as the fingerprint, palm pattern, iris, and face of the user can be used as the reader 3, and other devices can be used as the reader 3.

What is claimed is:

1. An entry and exit control apparatus comprising:
an entry and exit history storage unit in which entry and exit information is cumulatively stored, the entry and exit information comprising a user, a controlled area which the user enters and exits, a type of entry and exit, and entry and exit date and time being related to one another in the entry and exit information;
a staying time information storage unit in which staying time information is stored, a user staying time being statistically processed in each controlled area in the staying time information;
a traveling time information storage unit in which traveling time information is stored, a user traveling time between two controlled areas being statistically processed in the traveling time information;
a missing determination unit which determines whether or not the entry and exit information stored in the entry and exit history storage unit is missing for each user;
an estimation unit which estimates entry and exit date and time for the entry and exit information on the user that the missing determination unit determines is missing based on the staying time information on the corresponding controlled area and the traveling time information between the two corresponding controlled area, the staying time information on the corresponding controlled area being stored in the staying time information storage unit, the traveling time information between the two corresponding controlled areas being stored in the traveling time information storage unit;
a complementary entry and exit information extraction unit which extracts complementary entry and exit information from the pieces of entry and exit information stored in the entry and exit history storage unit based on the entry and exit date and time estimated by the estimation unit, the complementary entry and exit information complementing the entry and exit information on the user that the missing determination unit determines is missing; and
a complementary unit which complements the entry and exit information that the missing determination unit determines the missing item by the complementary entry and exit information extracted by the complementary entry and exit information extraction unit.

2. The entry and exit control apparatus according to claim 1, wherein the complementary unit makes an inquiry whether or not complementation is performed by the entry and exit information extracted by the complementary entry and exit information extraction unit, and the complementary unit complements the missing entry and exit information in response to the inquiry.

3. The entry and exit control apparatus according to claim 1, wherein the complementary entry and exit information extraction unit extracts the entry and exit information on the controlled area temporally closest to the entry and exit date and time estimated by the estimation unit in the pieces of entry and exit information stored in the entry and exit history storage unit.

4. The entry and exit control apparatus according to claim 1, wherein a time during which a door of the controlled area is opened is also related in the entry and exit information, the door restricting the entry and exit of the user into and from the controlled area, and
the complementary entry and exit information extraction unit extracts the entry and exit information on the corresponding controlled area, in which the time during which a door of the controlled area is opened becomes maximum in a period of time having a predetermined time interval around the entry and exit date and time estimated by the estimation unit, as the complementary entry and exit information from the pieces of entry and exit information stored in the entry and exit history storage unit.

5. The entry and exit control apparatus as in claim 1, wherein the missing determination unit determines whether or not the entry and exit information on the user is missing when the entry and exit information is stored in the entry and exit history storage unit.
